(19) United States
(12) Patent Application Publication
(10) Pub. No.: US 2001/0056397 A1
(43) Pub. Date: Dec. 27, 2001

(54) SYSTEM AND METHOD FOR TRACKING AND MODIFYING A MORTGAGE RATE

(76) Inventors: Keith Kelly, Vienna, VA (US); Joseph Kelly, Fairfax, VA (US)

Correspondence Address: OBLON SPIVAK MCCLLLAND MAIER & NEUSTADT, FOURTH FLOOR, 1755 JEFFERSON DAVIS HIGHWAY, ARLINGTON, VA, 22202

(21) Appl. No.: 09/453,231

(22) Filed: Dec. 3, 1999

(51) Int. Cl. G06F 17/60

(52) U.S. Cl. 705/38

(57) ABSTRACT

A computer-based method and system for controlling the mortgage rate charged to a mortgagee as a prevailing mortgage rate drops. Using an Automatic Rate Cut (A.R.C.) mortgage, a customer's interest rate may be reduced without going through a traditional refinance process. The A.R.C. Loan offers a model of financing for both purchasing or refinancing property (e.g., a residence). Once the customer has been in the program for a specified period since settlement date, the interest rate can be modified down provided that interest rates have declined since the customer entered the A.R.C. Loan. Secondary conditions can also be used to determine if the mortgage qualifies for a rate reduction.

### BACKGROUND OF THE INVENTION

1. Field of the Invention

The present invention is directed to a computer-based method and system for controlling financial data, and more specifically to a computer-based method and system for controlling a mortgage rate charged to a mortgagee as prevailing mortgage rates drop.

2. Discussion of the Background

Known mortgages take the form of fixed and adjustable rate mortgages. As is clear from its name, a fixed rate mortgage retains the same rate throughout the lifetime of the mortgage (e.g., 15 or 30 years). On the other hand, known adjustable rate mortgages (ARMs) start out at an initial rate and increase over the term of the loan, usually up to a fixed maximum and in fixed increments.

As market conditions change, prevailing mortgage rates change as well. Often a mortgagee can refinance a mortgage by taking a new mortgage at a lower rate and paying off the existing mortgage with the proceeds from the new mortgage. However, refinancing often includes closing costs and “points” paid for creating the new loan. In addition, the new mortgage company is obliged to perform a new title search to ensure that the property has not been encumbered since the original mortgage was obtained.

This process of refinancing is also costly for the service bureau servicing the mortgage and the investor that provided the mortgagee with the money, since the mortgagee often refinances with a different investor/lender using a different service bureau. Specifically, the service bureau is no longer collecting fees for servicing the loan. Likewise, the investor is no longer receiving a return on the investment and must now seek a new investment opportunity (with its own opportunity costs).

Often mortgagees are unaware of whether market conditions are sufficiently attractive to warrant refinancing. Accordingly, known consumer service organizations have contacted mortgagees when rates fall to an attractive refinancing level. After executing a new mortgage (with its associated refinancing costs), the mortgagee enjoys the benefits of the new rate, until the rates fall yet again and the process must be repeated anew (with costs incurred yet again).

### SUMMARY OF THE INVENTION

It is an object of the present invention to provide a new mortgage instrument that adjusts downward on behalf of the mortgagee as a prevailing mortgage rate drops, rather than requiring that a new mortgage (with a lower rate) be negotiated as a separate financial instrument.

It is a further object of the present invention to provide a computer-based method and system for tracking the prevailing mortgage rate to determine if a mortgagee's effective rate should be adjusted downward without negotiating a new mortgage instrument.

It is yet a further object of the present invention to provide a computer-based method and system for tracking the prevailing mortgage rate and various qualification factors to determine if a mortgagee's effective rate should be adjusted downward without negotiating a new mortgage instrument.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of a computer system for tracking mortgage rate conditions to determine if a mortgagee's effective rate should be adjusted downward without negotiating a new mortgage instrument;

FIG. 2 is a flowchart showing the method of determining if the mortgagee's effective rate should be adjusted downward;

FIG. 3 is a flowchart showing how exemplary qualification criteria are calculated according to one embodiment of the present invention;

FIG. 4 is a flowchart showing how a new mortgage payment is calculated when the mortgagee's effective rate has been adjusted downward;

FIG. 5 is a flowchart showing how a rnortgagee's mortgage payment changes between the old mortgage rate and the new mortgage rate;

FIG. 6 is a screenshot of an exemplary database structure for tracking whether or not a mortgagee's effective rate should be adjusted downward; and

FIG. 7 is a screenshot of an exemplary e-mail sent to the mortgagee to indicate that he/she qualifies for a rate reduction.

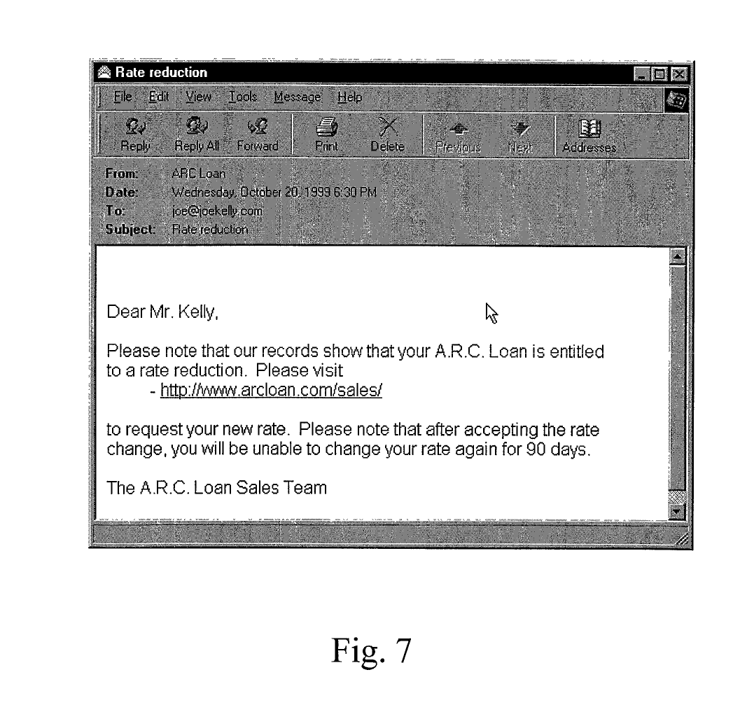

### DETAILED DESCRIPTION OF THE PREFERRED EMBODIMENTS

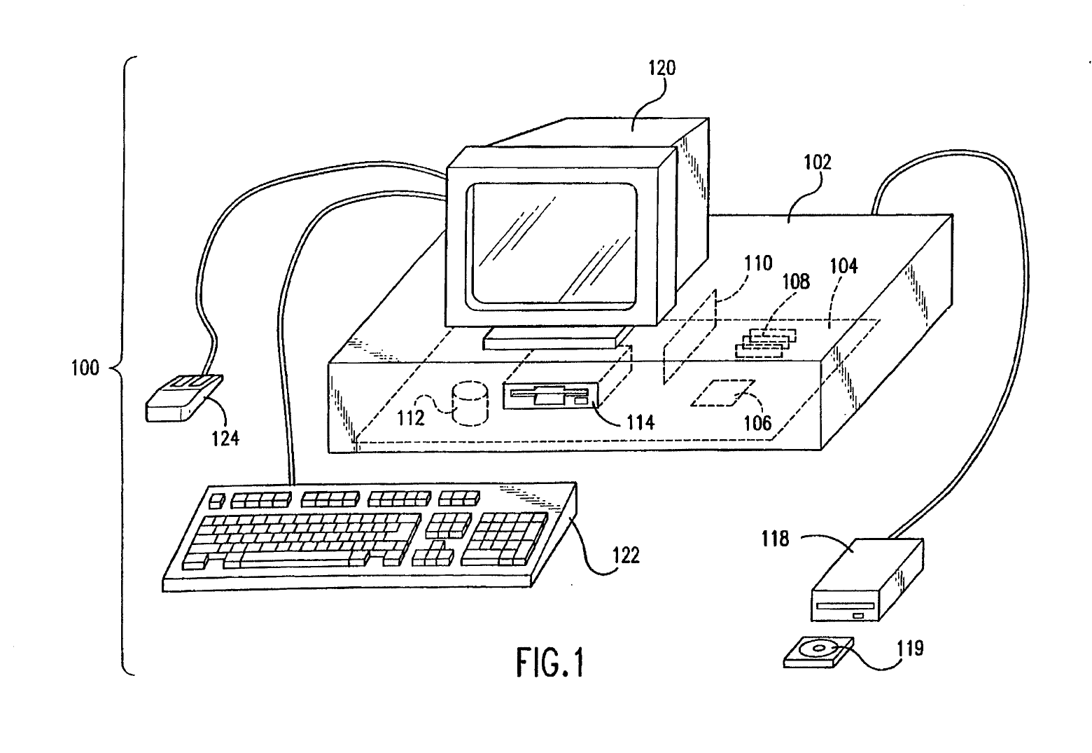

Referring now to the drawings, wherein like reference numerals designate identical or corresponding parts throughout the several views, FIG. 1 is a schematic illustration of a computer system for tracking prevailing market conditions to determine if a mortgagee's effective rate should be adjusted downward. A computer 100 implements the method of the present invention, wherein the computer housing 102 houses a motherboard 104 which contains a CPU 106, memory 108 (e.g., DRAM., ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of at least one of (1) existing mortgage rates of previously executed mortgages, (2) the prevailing mortgage rate, and (3) mortgages that may be changed based on changes in market conditions.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for analyzing market conditions to determine if a mortgage rate should be adjusted downward. The computer code devices of the present invention can be any interpreted or executable code mechanism, including but not limited to scripts, interpreters, Active X controls, dynamic link libraries, Java classes, and complete executable programs.

The present invention begins with a mortgagee contracting for (and obtaining) a new type of mortgage instrument that includes a contractual provision specifying that the mortgage rate of the instrument will decrease under certain market conditions, but will never increase above its lowest level. Such a mortgage instrument will be called an “A.R.C. Loan” throughout the remainder of the specification.

For a purchase transaction, the settlement date in which that loan closes will be used as the start date of the A.R.C. Loan for modification purposes. For a refinance transaction, the funding date will be used as the start date of the A.R.C. Loan for modification purposes.

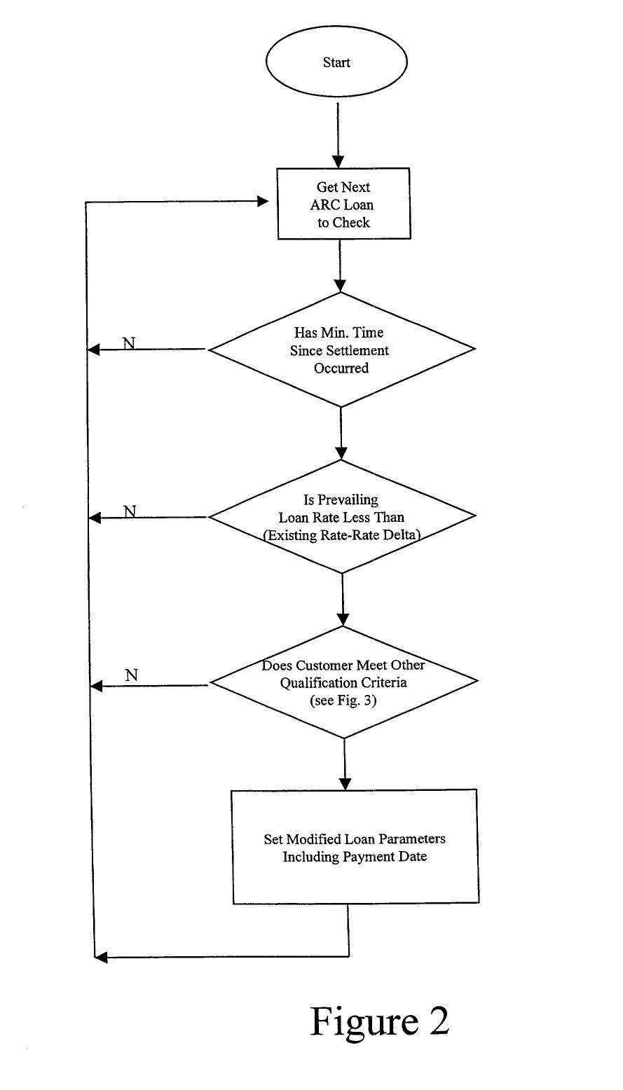

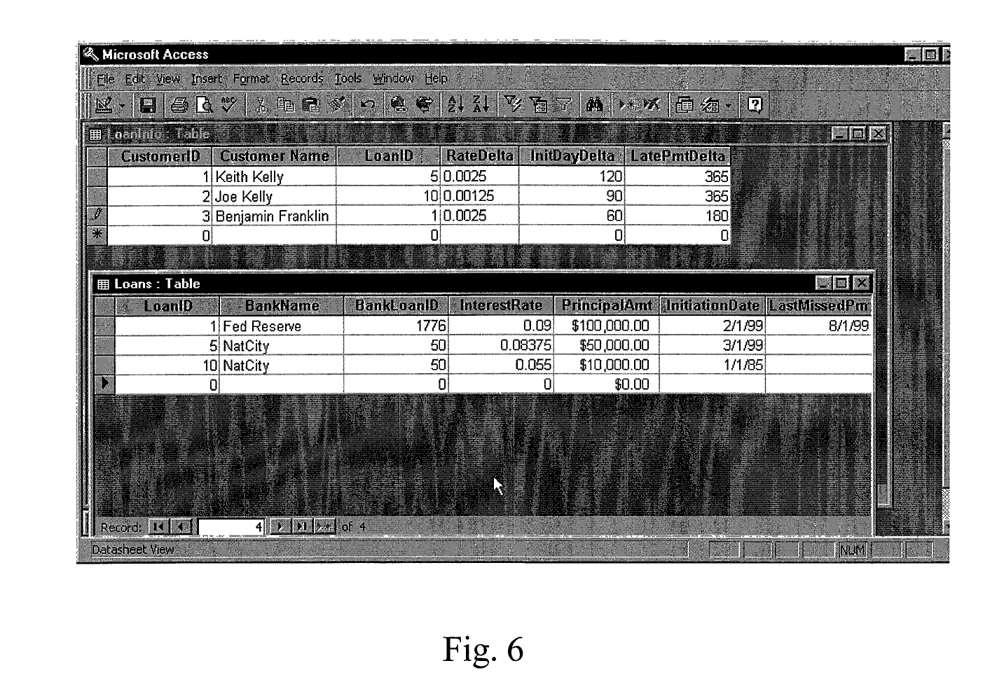

As shown in FIG. 2, a set of conditions must be met in order for the mortgage rate to be reduced. (As would be appreciated by one of ordinary skill in the art, the order of analyzing the set of conditions may be altered from the order described herein.) Different mortgages (and the method and system for tracking) are also not limited to using the same data values or even the same factors in determining if a mortgage rate should be reduced. As is shown in FIG. 6, different mortgagees (customers) may have negotiated different modification conditions.

Turning now to a non-limiting example of how a mortgage is tracked for possible reduction of the mortgage rate, a set of exemplary conditions are examined. As would be appreciated by one of ordinary skill in the art, other conditions negotiated by the parties (referred to herein as “secondary conditions”) can be tracked as well. Accordingly, the system determines if: (1) The prevailing interest rate currently being offered as the modification rate is less than the current interest rate on the mortgagee's current A.R.C. Loan—the RateDelta (e.g., 0.25 percentage points), and (2) a period of InitDayDelta must have elapsed from the more recent of the start date of the A.R.C. Loan or the last rate modification date. Once an A.R.C. Loan modifies downward, it can never go higher than its new modified interest rate. There are no limits to the amount of times an A.R.C. Loan can modify provided it meets the modification criteria set forth above and the secondary conditions, if any, described below.

The A.R.C. Loan modification rate may also be negotiated by the parties. In one embodiment, the prevailing rate equals an index rate plus a margin rounded to the nearest selected percentage point (e.g., ⅛ or 1/16 of a percentage point). The index rate used can be any selected index, e.g., the 60-day Fannie Mae mandatory delivery price. The margin is a negotiated term according to the lender or investor. The conforming loan limit will be the amount set by Fannie Mae.

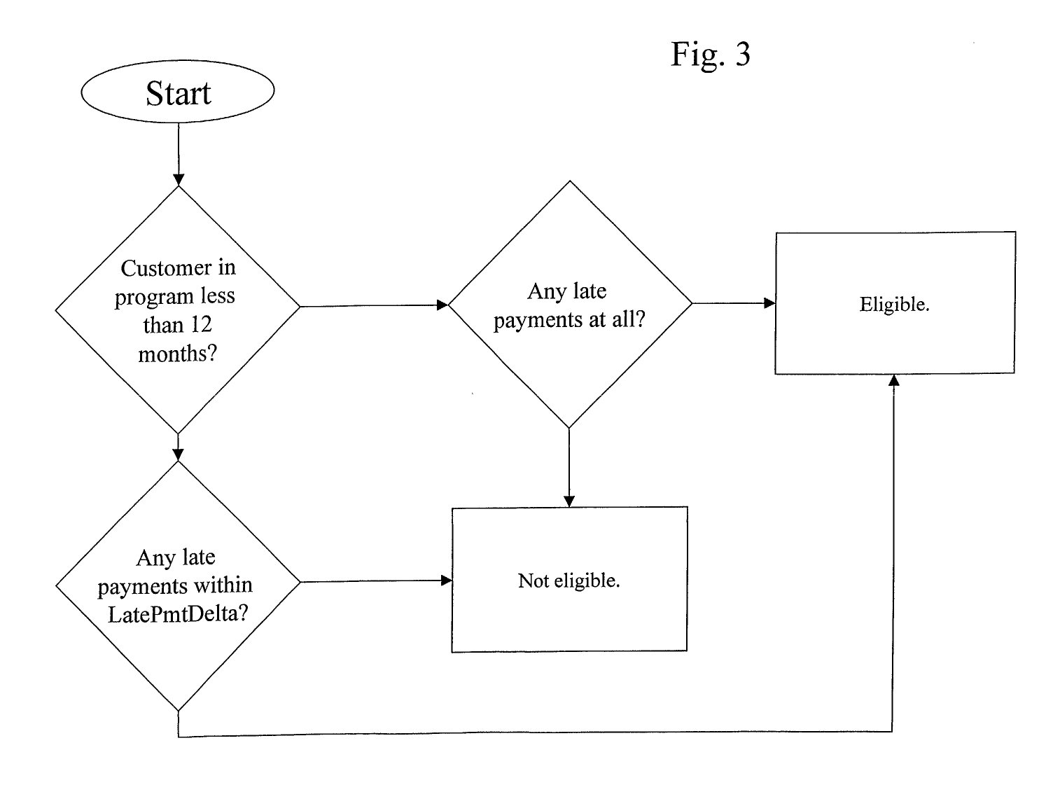

As shown in FIG. 3, exemplary secondary conditions may also be used to limit the conditions under which the mortgage qualifies for a rate reduction. For example, the mortgagee cannot have any 30-day late mortgage payments in the Late Payment Delta (e.g., 12 months), or if less than one year has elapsed since the initial settlement date on the A.R.C. Loan, the customer cannot have any 30-day late payment up to modification date.

### EXAMPLE OF A LOAN MODIFICATION

As shown in FIG. 6, a customer, Keith Kelly, negotiates an A.R.C. Loan to buy a home, which settled on Initiation Date Feb. 1, 1999. After waiting InitDayDelta days (i.e., 120 days for Keith's loan) his loan is eligible for a modification. On October 1^{st}, Keith checks the arcloan.com web site to see if the prevailing modification rate is RateDelta (e.g., 0.25 percentage points) lower than his existing current interest rate. Using a Web browser or an e-mail program, Keith requests a modification online. Unfortunately, due to a 30-day late payment on Aug. 1, 1999, Keith is not eligible for a reduction.

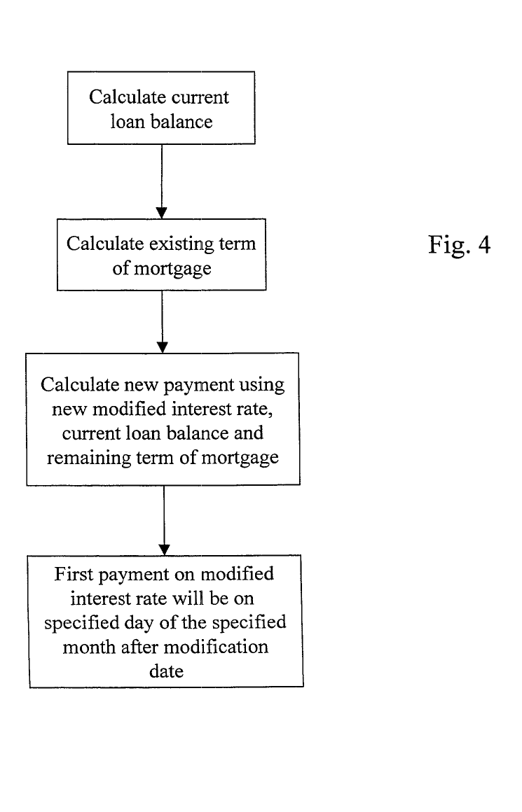

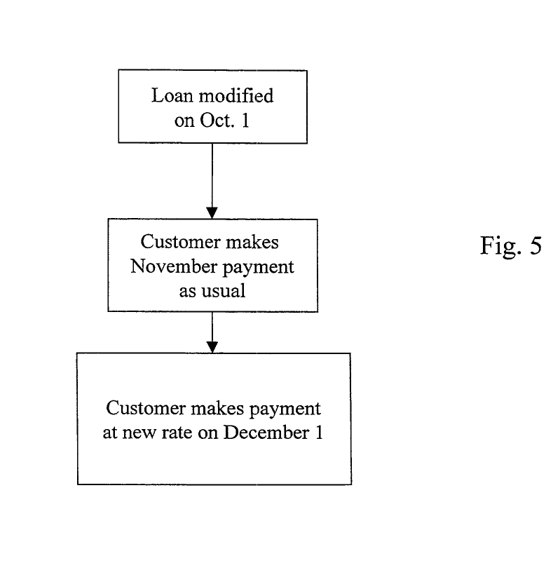

Keith's brother, Joe, however, has been in the program more than InitDayDelta days (i.e., 90 days for Joe's loan) and has not had any late payments, so if the prevailing rate is RateDelta (0.125 percentage points) lower than his existing rate of 8.375 percent, then his rate will be reduced. Accordingly, as shown in FIG. 4, Joe's loan is modified down to reflect the prevailing rate and his new payment is calculated. As shown in FIG. 5, Joe will make his November payment at his old interest rate amount, but will begin paying his new modified mortgage payment on December 1^{st}. Joe can again modify his loan rate Initial Day Delta, 90 days, from October 1^{st}, the date of the last reduction.

In order to provide a method and system for issuing and/or tracking A.R.C. Loans, the present invention tracks various parameters. These parameters may either be written to and read from a database, as shown in FIG. 6, or may be stored on any other non-volatile media. In order to check externally changing conditions (e.g., an index rate), the method and system may either receive data entered manually or may contact an external data source (e.g., a financial web site or bulletin board service) to obtain the latest condition. Contacting an external data source may be accomplished by either a network connection (e.g., an Ethernet connection) or by a dial-up connection. Likewise, the condition (preferably digitally signed) also can be e-mailed to the system of the present invention.

Modifications

Although described above in terms of the preferred embodiment, variations on the above may be made without departing from the spirit of the invention. For example, the change in interest rate may occur on a specified day of the month other than the first day of the month following the month.

In determining when a rate cut should occur, the present invention can use either a user-initiated change or a system-initiated change. In a user-initiated change, the user calls his A.R.C. Loan representative or visits the arcloan.com Web site to request a rate reduction. As would be understood by one of ordinary skill in the art, a web site can retrieve data from a database using a number of techniques. One such technique is Active Server Pages, as described in Active Server Pages 2.0 by Francis et al., the contents of which are incorporated herein by reference. In a system-initiated change, each mortgagee that qualifies for a rate reduction on the current day is contacted (e.g., by e-mail or by pre-recorded telephone message) to determine if he/she wishes to reduce his/her rate now or wait longer.

According to the present invention, the prevailing interest rate may also include some number of percentage points which act as a profit margin for the investor. Thus, the prevailing rate is actually a known index value plus the investor's profit margin. Accordingly, the data processing system rounds the result of this addition to the nearest fixed increment (e.g., one-eighth or one-sixteenth of one percentage point (0.125% or 0.0625%)) to create the prevailing rate.

The system will also calculate the payment to repay the current principal amount owed over the original Term period. I.e., if there are 28 years remaining on a 30 year mortgage the borrower can choose to repay their current principal amount over the remaining 28 year term or a new 30 year term.

The system will also calculate the payment by adding the cost involved if the borrower chooses to buydown their modification rate by paying points (prepaid interest). The system will calculate the payment with the points (prepaid interest) added to the current principal balance for the remaining Term and for the original Term period. I.e., if the modification interest rate is 8.5% with no closing costs and 8% with 2 points (2% of the remaining principal balance) the borrower will have the choice of the modification rate with no costs or the modification rate with points. The borrower will have the option of adding the 2 points back to the remaining balance provided it does not exceed the original financed amount.

From the prevailing rate, the system can calculate the amount of the monthly payment that would be sufficient to repay in full, on the Maturity Date, the unpaid principal that the mortgagee is expected to owe on the day of the rate modification at the new interest rate in substantially equal payments. The result of this calculation will be the new monthly payment amount.

In order to protect the investor, additional conditions controlling the rate change may include: (1) a maximum rate drop per year, and (2) a maximum rate drop over the life of the mortgage. As part of the negotiation of the original mortgage, the investor will determine the limits to which interest rate can be lowered. This is important because once an interest rate is lowered, the interest rate can never go higher again.

In addition to the processing performed on behalf of the mortgagee, in one embodiment, the present invention also provides administrative processing. The system generates a notification which the Note Holder will deliver or mail to the mortgagee of any changes in the interest rate and the new monthly payment amount before the effective date of any change. The notice will include any information required by law and also the title and telephone number of a person who will answer any questions that the consumer may have regarding the notice.

As a further extension of the administrative system, consumers, through the web site, can register to be informed of the availability of A.R.C. loans at or below a specified rate. Thus, although a consumer may not be interested in an A.R.C. loan at the moment, the consumer can automatically be notified when the system determines that the prevailing A.R.C. loan rate is attractive to the consumer. In one embodiment of the present invention, not only the rate but also a specific set of negotiated conditions are registered with the web site. Thus, a user that wants a selected rate but a 90 day InitDayDelta is not bothered when the selected rate is available but only with a 120 day InitDayDelta.

Obviously, numerous modifications and variations of the present invention are possible in light of the above teachings without departing from the intended scope of the present invention.

1. A computer program product, comprising:
a computer storage medium and a computer program code mechanism embedded in the computer storage medium for causing a computer to control the mortgage rate of an Automatic Rate Cut (ARC) mortgage, the computer program code mechanism comprising:
a first computer code device configured to determine a prevailing interest rate;
a second computer code device configured to determine an interest rate of an ARC mortgage;
a third computer code device configured to determine if the interest rate of the ARC mortgage was modified downward within the last InitDayDelta days;
a fourth computer code device configured to (1) lower the interest rate to the new prevailing rate and (2) reset a starting period for calculating the last InitDayDelta days if the prevailing rate is less than the prevailing rate minus the RateDelta of the mortgage.

2. The computer program product as claimed in claim 1, further comprising a fifth computer code device configured to calculate the prevailing rate using a published index rate plus a profit margin.

3. The computer program product as claimed in claim 1, wherein the fourth computer code device comprises a fifth computer code device configured to lower the interest rate only after receiving authorization from a corresponding customer.

4. The computer program product as claimed in claim 3, wherein the fifth computer code device comprises a sixth computer code device configured to receive authorization on a web server.

5. The computer program product as claimed in claim 1, wherein the fourth computer code device comprises a fifth computer code device configured to lower the interest rate automatically without receiving authorization from a corresponding customer.

6. The computer program product as claimed in claim 1, wherein the fourth computer code device comprises a fifth computer code device configured to verify secondary conditions before authorizing the interest rate to be lowered.

7. The computer program product as claimed in claim 1, wherein the fifth computer code device comprises a sixth computer code device configured to check a payment history of the mortgage.

8. The computer program product as claimed in claim 1, wherein the fifth computer code device comprises a sixth computer code device configured to check a maximum interest rate drop of the mortgage.

9. A mortgage created according to the steps of:
a) negotiating an interest rate for an initial principal amount to be repaid during a lifetime of the mortgage;
b) negotiating an amount by which a prevailing interest rate must be lower than the interest rate of the mortgage before the interest rate of the mortgage can be lowered without ever increasing;
c) negotiating a period during which the interest rate cannot be lowered after at least one of an initiation of the mortgage and a day on which the interest rate was last lowered; and
d) negotiating if any secondary conditions limit an ability to lower the interest rate.

10. A mortgage created according to the steps of claim 9, wherein the steps a) through d) are performed on a computer.
